(19) United States
(12) Patent Application Publication
(10) Pub. No.: US 2014/0037894 A1
(43) Pub. Date: Feb. 6, 2014

(54) COMPOSITION FOR HEAT-INSULATING MATERIAL AND HEAT-INSULATING MATERIAL

(71) Applicants: Hisato Higuchi, Sakai-shi (JP); Shinsuke Takeda, Sakai-shi (JP); Nagaharu Hara, Sakai-shi (JP); Tetsuro Ise, Sakai-shi (JP); Junko Watanabe, Tokyo (JP); Aiichiro Tsukahara, Tokyo (JP); Masayuki Yamashita, Tokyo (JP); Fumihito Takeda, Tokyo (JP)

(72) Inventors: Hisato Higuchi, Sakai-shi (JP); Shinsuke Takeda, Sakai-shi (JP); Nagaharu Hara, Sakai-shi (JP); Tetsuro Ise, Sakai-shi (JP); Junko Watanabe, Tokyo (JP); Aiichiro Tsukahara, Tokyo (JP); Masayuki Yamashita, Tokyo (JP); Fumihito Takeda, Tokyo (JP)

(73) Assignees: MITSUBISHI HEAVY INDUSTRIES, LTD., Tokyo (JP); LIGNYTE CO., LTD., Sakai-shi, Osaka (JP)

(21) Appl. No.: 14/000,969

(22) PCT Filed: Feb. 23, 2012
(86) PCT No.: PCT/JP2012/001237

§ 371 Date: Oct. 23, 2013

(30) Foreign Application Priority Data
Mar. 2, 2011 (JP) 2011-044940

(51) Int. Cl. C08J 9/00

(52) U.S. Cl. CPC C08J 9/0085
USPC 428/117; 252/62

(57) ABSTRACT

Provided is a composition for a lightweight heat-insulating material having high heat-insulating properties. The composition for a heat-insulating material contains a fibrous material, inorganic foamed particles, a thermosetting resin, and a foaming agent. Since the composition for a heat-insulating material contains the inorganic foamed particles and the foaming agent in addition to the fibrous material and the thermosetting resin, the weight can be reduced and the thermal conductivity can be lowered due to the inorganic foamed particles having low specific gravity. Further, the thermosetting resin is caused to foam by the foaming agent, and the weight can be reduced and the thermal conductivity can be lowered. A lightweight heat-insulating material having high-insulating properties can be obtained.

### TECHNICAL FIELD

The present invention relates to a composition for a heat-insulating material used in air or in vacuum, and a heat-insulating material, and particularly relates to a heat-insulating material suitable for heat insulation to protect an airframe of a reentry vehicle or the like from aerodynamic heating when the reentry vehicle or the like enters the atmosphere from space.

### BACKGROUND ART

In general, a heat-insulating material is formed by using a material having a low thermal conductivity. In a reentry vehicle such as a space plane or a rocket used in space, in addition to having such a low thermal conductivity, a heat-insulating material used for airframe protection breaks down or carbonizes itself to consume thermal energy when the temperature is raised to high temperature in reentering the atmosphere, thereby preventing the inside of an airframe from being raised to high temperature (e.g., see Patent Literature 1 and 2).

As such a heat-insulating material, a material is used which is produced by mixing a fibrous material and a thermosetting resin and molding the mixture to harden the thermosetting resin. However, the heat-insulating material produced thus has a bulk specific gravity of about 1.6 and is heavy, and its thermal conductivity is equal to or higher than 0.55 W/(m·K) which is high. Thus, the material is problematic as a heat-insulating material in terms of performance and function.

### CITATION LIST

### Patent Literature

[PTL 1] Japanese Laid-Open Patent Publication No, 2000-280389

[PTL 2] Japanese Laid-Open Patent Publication No. 2001-247100

### SUMMARY OF THE INVENTION

### Problems to be Solved by the Invention

The present invention has been made in view of the above-described points, and an object of the present invention is to provide a composition for a lightweight heat-insulating material having high heat-insulating properties, and such a heat-insulating material.

### Solution to the Problems

A composition for a heat-insulating material according to the present invention contains a fibrous material, inorganic expanded particles, a thermosetting resin, and an expanding agent.

When high temperature is applied, the thermosetting resin is broken down, burnt, sublimated, and carbonized to consume the thermal energy, whereby it is possible to block the high temperature from being transmitted through the heat-insulating material and to obtain high heat-insulating properties. In addition, by a reinforcing effect of the fibrous material, it is possible to increase the mechanical strength of the heat-insulating material. Since the inorganic expanded particles and the expanding agent are contained in addition to the fibrous material and the thermosetting resin, the low-specific-gravity inorganic expanded particles allow for reduction in the thermal conductivity while achieving weight reduction, and the expanding agent allows the thermosetting resin to be expanded, thereby reducing the thermal conductivity while achieving weigh reduction. Thus, it is possible to mold a lightweight heat-insulating material having high heat-insulating properties.

In addition, in the present invention, a polyvinyl alcohol-based material selected from a polyvinyl alcohol and a polyvinyl acetal resin is contained.

When the polyvinyl alcohol-based material is broken down, water is generated. In addition, thermal energy is consumed when the polyvinyl alcohol-based material is broken down, and the thermal energy is consumed also by vaporization of the generated water. Thus, by the consumption of the thermal energy, it is possible to obtain higher heat-insulating properties of blocking heat.

In addition, in the present invention, cork particles are contained.

Since the cork particles are contained, it is possible to reduce the thermal conductivity while achieving weight reduction. In addition, the cork particles are broken down, burnt, sublimated, and carbonized to consume thermal energy, whereby it is possible to block high temperature from being transmitted through the heat-insulating material and to obtain high heat-insulating properties.

In addition, in the present invention, a material selected from inorganic fibers such as alumina fibers, glass fibers, silica fibers, oxide-based inorganic fibers such as alumina-silica composite oxide fibers, silicon carbide fibers, boron fibers, and carbon fibers; and organic fibers such as aramid fibers, poly para-phenylene benzobisoxazole fibers, acrylic fibers, acetate fibers, nylon fibers, and vinylidene fibers, is used as the fibrous material.

Each of these inorganic fibers exerts a reinforcing effect when the heat-insulating material is either in a low-temperature state or in a high-temperature state. Each of these organic fibers exerts a reinforcing effect when the heat-insulating material is in a low-temperature state. In addition, when the heat-insulating material is in a high-temperature state, each of these organic fibers is broken down, burnt, sublimated, and carbonized to consume thermal energy, thereby being able to contribute to heat-insulating properties.

In addition, in the present invention, a resin selected from phenol resins, furan resins, polyimides, silicone resins, epoxy resins, unsaturated polyesters, polyurethanes, melamine resins, and modified resins thereof, is used as the thermosetting resin.

Since these thermosetting resins are used, it is possible to mold a heat-insulating material having favorable performance.

A heat-insulating material according to the present invention is formed by expanding and hardening the above composition for a heat-insulating material, and thus can be obtained as a lightweight heat-insulating material having high heat-insulating properties as described.

The heat-insulating material according to the present invention has a bulk specific gravity of 1.0 or less and a thermal conductivity of 0.2 W/(m·K) or less, and thus it is possible to obtain a sufficiently lightweight heat-insulating material having sufficiently high heat-insulating properties.

In addition, a heat-insulating material according to the present invention is formed by expanding and hardening the above composition for a heat-insulating material within voids of a honeycomb structure, the honeycomb structure becomes a skeleton, and thus it is possible to obtain a heat-insulating material having high strength.

### Advantageous Effects of the Invention

Since the composition for a heat-insulating material according to the present invention contains the fibrous material, the inorganic expanded particles, the thermosetting resin, and the expanding agent, when high temperature is applied, the thermosetting resin is broken down, burnt, sublimated, and carbonized to consume the thermal energy, whereby it is possible to block the high temperature from being transmitted through the heat-insulating material and to obtain high heat-insulating properties. In addition, a heat-insulating effect is obtained even by formation of, on the surface of the heat-insulating material, a layer of gas generated by the breakdown and the like of the thermosetting resin. Moreover, the fibrous material increases the mechanical strength of the heat-insulating material. Furthermore, since the inorganic expanded particles and the expanding agent are contained in addition to the fibrous material and the thermosetting resin, the low-specific-gravity inorganic expanded particles allow for reduction in the thermal conductivity while achieving weight reduction, and the expanding agent allows the thermosetting resin to be expanded, thereby reducing the thermal conductivity while achieving weight reduction. Thus, it is possible to obtain a lightweight heat-insulating material having high heat-insulating properties.

### BRIEF DESCRIPTION OF THE DRAWINGS

FIG. 1 is a schematic cross-sectional view showing one example of an embodiment of the present invention.

FIG. 2 shows another example of the embodiment of the present invention, (a) is a partially-cutaway schematic perspective view, and (b) is a schematic diagram showing an example of a honeycomb structure.

### DESCRIPTION OF EMBODIMENTS

Hereinafter, embodiments of the present invention will be described.

A composition for a heat-insulating material according to the present invention is prepared containing a fibrous material, inorganic expanded particles, a thermosetting resin, and an expanding agent. It is possible to obtain a heat-insulating material according to the present invention by expanding and hardening the composition.

The thermosetting resin is not particularly limited, but examples of the thermosetting resin include phenol resins, furan resins, polyimides, silicone resins, epoxy resins, unsaturated polyesters, polyurethanes, melamine resins, and modified resins thereof. One type of them may be used solely, or a plurality of types of them may also be mixed and used.

Here, as a phenol resin, a phenol resin may be used which is prepared by reacting a phenol with an aldehyde in the presence of a catalyst. A phenol refers to phenol or a derivative of phenol, and examples of phenols include, in addition to phenol, trifunctional phenols such as resorcinol and 3,5-xylenol, tetrafunctional phenols such as bisphenol A and dihydroxydiphenylmethane, bifunctional o- or p-substituted phenols such as o-cresol, p-cresol, p-ter-butylphenol, p-phenylphenol, p-cumylphenol, p-nonylphenol, and 2,4- or 2,6-xylenol. In addition, halogenated phenols substituted with chlorine or bromine, and the like can also be used. As a matter of course, one type may be selected from them and used, or a plurality of types of them may also be mixed and used.

As the aldehyde, formalin in the form of an aqueous solution is most appropriate, but aldehydes such as paraformaldehyde, acetaldehyde, benzaldehyde, trioxane, and tetraoxane can also be used. In addition, it is also possible to use formaldehyde that is partially substituted with 2-furaldehyde or furfuryl alcohol. As a matter of course, one type may be selected from them and used, or a plurality of types of them may also be mixed and used.

The blending ratio between the phenol and the aldehyde is preferably set so as to be in the range of 1:0.5 to 1:3.5 in mole ratio.

As the catalyst, inorganic acids such as hydrochloric acid, sulfuric acid, and phosphoric acid, organic acids such as oxalic acid, para-toluenesulfonic acid, benzenesulfonic acid, and xylensulfonic acid, and divalent metal salts such as zinc acetate can be used when a novolac type phenol resin is prepared. When a resol type phenol resin is prepared, oxides or hydroxides of alkaline earth metals can be used, and further amines such as dimethylamine, triethylamine, butylamine, dibutylamine, tributylamine, diethylenetriamine, and dicyandiamide, ammonia, hexamethylenetetramine, etc., and hydroxides of the other divalent metals can also be used.

Each of a novolac type phenol resin and a resol type phenol resin may be used solely, or both of them may be mixed in an arbitrary ratio and used. Various types of modified phenol resins, such as silicon-modified phenol resins, rubber-modified phenol resins, and boron-modified phenol resins, can also be used.

The blending amount of the thermosetting resin in the composition for a heat-insulating material is not particularly limited, but is preferably in the range of 10 to 60 mass %. The thermosetting resin is blended mainly as a binding of (binder) component. If the blending amount is less than 10 mass %, the adhesive force is insufficient, and there is a concern that the strength of the heat-insulating material becomes insufficient. If the blending amount exceeds 60 mass %, the bulk density of the heat-insulating material is increased, and it becomes difficult to reduce the weight of the heat-insulating material.

Next, the fibrous material is not particularly limited, but as the fibrous material, inorganic fibers such as alumina fibers, glass fibers, silica fibers, oxide-based inorganic fibers such as alumina-silica composite oxide fibers, silicon carbide fibers, boron fibers, and carbon fibers; and organic fibers such as aramid fibers, poly para-phenylene benzobisoxazole fibers, acrylic fibers, acetate fibers, nylon fibers, and vinylidene fibers, can be used. One type of them may be used solely, or a plurality of types of them may also be used in combination.

The fiber diameter and the fiber length of the fibrous material are not particularly limited, but the fiber diameter is preferably in the range of 1 to 30 μm, and the fiber length is preferably in the range of 1 to 30 mm.

In addition, the blending amount of the fibrous material in the composition for a heat-insulating material is not particularly limited, but is preferably in the range of 1 to 50 mass %. The fibrous material is used mainly to reinforce the heat-insulating material. If the blending amount is less than 1 mass %, the reinforcing effect cannot be sufficiently obtained. On the other hand, if the blending amount exceeds 50 mass %, the dispersibility of the fibrous material to the composition for a heat-insulating material is deteriorated, and there is a concern that the uniformity of the heat-insulating material is impaired.

Next, the inorganic expanded particles are not particularly limited, but hollow balloons of glass, such as low alkali glass, soda lime glass, borosilicate glass, sodium borosilicate glass, and aluminosilicate, and of minerals, such as Shirasu, can be used. As the inorganic expanded particles, one type may be selected from them and used, or a plurality of types of them may also be mixed and used. The particle size of the inorganic expanded particles is not particularly limited, but is preferably in the range of 1 to 1000 μm.

The bulk specific gravity of the inorganic expanded particles is not particularly limited, but is preferably in the range of 0.05 to 0.5. The inorganic expanded particles are contained mainly to reduce the weight of the heat-insulating material and to decrease the thermal conductivity of the heat-insulating material to improve the heat-insulating properties. If the bulk specific gravity exceeds 0.5, the effect of weight reduction and heat-insulating properties improvement cannot be sufficiently obtained. In addition, if the bulk specific gravity of the inorganic expanded particles is less than 0.05, the strength of the inorganic expanded particles is decreased, and thus there is a concern that the strength of the heat-insulating material is decreased.

The blending amount of the inorganic expanded particles in the composition for a heat-insulating material is not particularly limited, but is preferably in the range of 5 to 50 mass %. If the blending amount is less than 5 mass %, the effect of weight reduction and heat-insulating properties improvement by blending the inorganic expanded particles cannot be sufficiently obtained. On the other hand, if the blending amount exceeds 50 mass %, there is a concern that the strength of the heat-insulating material is decreased.

Next, the expanding agent is not particularly limited, but examples of the expanding agent include inorganic expanding agents such as ammonium carbonate and sodium hydrogen carbonate, organic expanding agents such as dinitro pentamethylene tetramine, azodicarbonamide, p,p′-oxybenzene sulfonylhydrazine, and hydradicarbonamide, and a microcapsule expanding agent obtained by encapsulating a low-boiling-point hydrocarbon with a shell wall of a copolymer such as vinylidene chloride, acrylonitrile, or polyurethane. One type of them may be used solely, or a plurality of types of them may also be used in combination.

The expanding agent is intended to expand the thermosetting resin, thereby reducing the weight of the heat-insulating material and also decreasing the thermal conductivity of the heat-insulating material to improve the heat-insulating properties. Its expansion ratio is preferably set so as to be about 2 to 5 times. If the expansion ratio is less than 2 times, the effect of weight reduction and heat-insulating properties improvement cannot be sufficiently obtained. On the other hand, if the expansion ratio exceeds 5 times, it is not preferred since the strength of the heat-insulating material is decreased. In addition, the blending amount of the expanding agent is set as appropriate according to the intended expansion ratio and is not particularly limited, but is preferably in the range of 5 to 20 parts by mass per 100 parts by mass of the thermosetting resin.

In addition, in order to enhance the adhesion between the fibrous material or the inorganic expanded particles and the thermosetting resin, a coupling agent such as γ-aminopropyl triethoxysilane, γ-(2-aminoethyl)aminopropyl trimethoxysilane, or γ-glycidoxypropyl trimethoxysilane may be added to the composition for a heat-insulating material.

It is possible to prepare the composition for a heat-insulating material according to the present invention by blending and kneading the fibrous material, the inorganic expanded particles, the thermosetting resin, and the expanding agent with a kneading apparatus such as a Henschel mixer, a Simpson mill, a melangeur, an Eirich mixer, a speed muller, or a whirl mix. These kneading apparatuses may be selectively used as appropriate depending on the form and the properties of the binder component, or a kneading method.

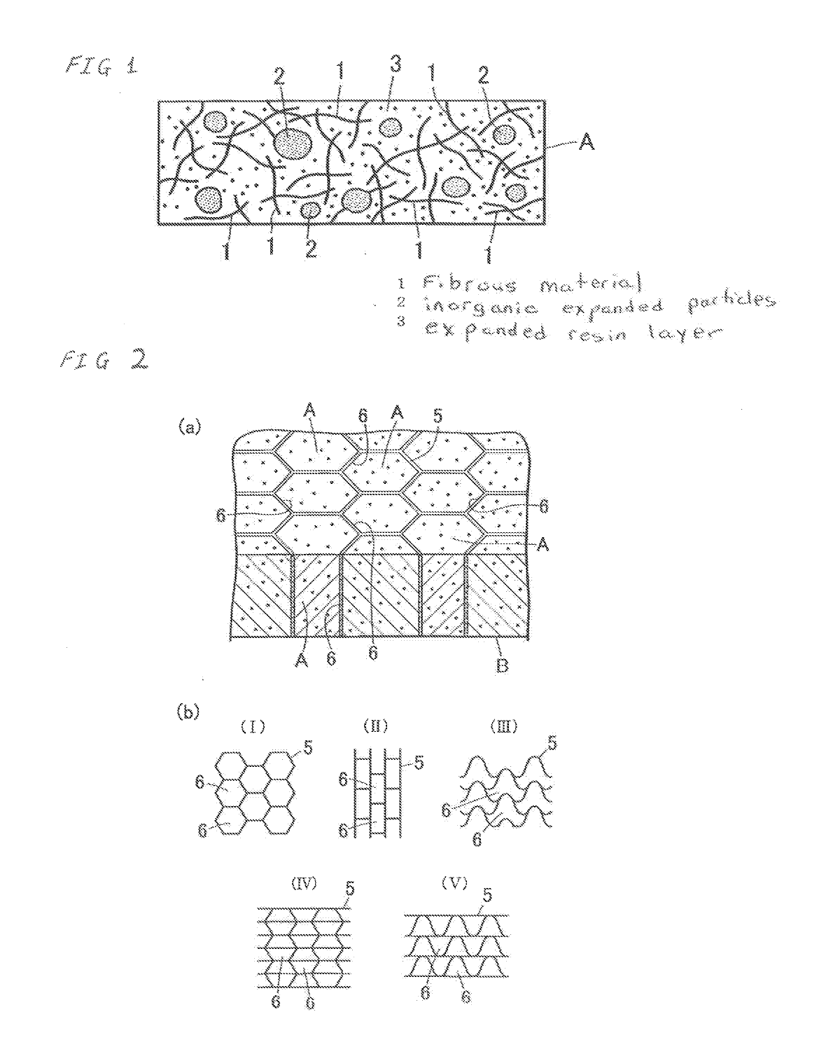

Moreover, a heat-insulating material A can be obtained by putting the thus-prepared composition for a heat-insulating material into a mold and heating the mold to harden the thermosetting resin in a state where the thermosetting resin is melted and expanded. FIG. 1 shows the heat-insulating material A, and the heat-insulating material A can be produced in which a fibrous material 1 and inorganic expanded particles 2 are dispersed in an expanded resin layer 3 formed by expanding and hardening the thermosetting resin. Since the fibrous material 1 is contained so as to be dispersed in the expanded resin layer 3 as described above, it is possible to reinforce the heat-insulating material A by the fibrous material 1, and it is possible to increase the mechanical strength of the heat-insulating material A.

The inorganic expanded particles 2 are contained in the heat-insulating material A, and the expanded resin layer 3 formed by expanding the thermosetting resin with the expanding agent forms a matrix of the heat-insulating material A. Thus, the heat-insulating material A is formed with a low bulk density, and its thermal conductivity is also low. Therefore, it is possible to obtain the heat-insulating material A which is lightweight and has high heat-insulating properties. Here, the bulk specific gravity of the heat-insulating material A is not particularly limited, but is preferably not greater than 1.0, and is preferably in the range of 0.3 to 1.0. In addition, the thermal conductivity of the heat-insulating material A is preferably not greater than 0.2 W/(m·K), and is preferably in the range of 0.1 to 0.2 W/(m·K).

The heat-insulating material A, according to the present invention, produced as described above is used in air or in vacuum, and can be used as a heat-insulating material for protecting an airframe flying at a high speed, for example, a reentry vehicle such as a space plane, a recovery capsule, or a rocket. Such an airframe flying at a high speed is heated to high temperature by friction with the atmosphere, and in particular, when the airframe reenters the atmosphere of the earth from space, the aerodynamic heating is at about 1 to 5 MW/m². Thus, the airframe is exposed to very high temperature.

When high temperature is applied to the heat-insulating material A as described above, the thermosetting resin of the expanded resin layer 3, which is the matrix of the heat-insulating material A, breaks down, melts and sublimes, or burns and carbonizes, and the thermal energy is consumed by the latent heat absorption accompanying the phase change of the material in this case. By the consumption of the thermal energy as described above, it is possible to block high temperature from being transmitted through the heat-insulating material A. Furthermore, gas generated by the breakdown or sublimation comes out to and shields the surface of the heat-insulating material A to reduce application of high aerodynamic heating directly to the heat-insulating material A, whereby it is also possible to block high temperature from being transmitted through the heat-insulating material A. With such a heat-insulating effect of the heat-insulating material A blocking transmission of high temperature therethrough, it is possible to protect the inside of the airframe from high temperature.

Moreover, in the case where the fibrous material 1 contained in the heat-insulating material A is inorganic fibers, a reinforcing effect is exerted both at low temperature and at a time of application of high temperature. However, in the case where the fibrous material 1 is organic fibers, when high temperature is applied, the fibrous material 1 breaks down etc. similarly to the thermosetting resin of the expanded resin layer 3, to consume the thermal energy, thereby serving to block high temperature from being transmitted through the heat-insulating material A. Here, in the case where aramid fibers, poly para-phenylene benzobisoxazole fibers, acrylic fibers, or the like are used as organic fibers, these fibers break down and carbonize to be carbon fibers, and thus are able to keep the reinforcing effect as the carbon fibers.

In addition to each component described above, a polyvinyl alcohol-based material may be blended into the composition for a heat-insulating material according to the present invention. As the polyvinyl alcohol-based material, a polyvinyl alcohol, a polyvinyl acetal resin obtained by acetalization of a polyvinyl alcohol, or the like can be used. These materials may be used in the form of powder and granules, or may also be used in the form of spun fibers such as vinylon fibers. One type of these polyvinyl alcohol-based materials may be used solely, or a plurality of types of these polyvinyl alcohol-based materials may also be used in combination.

If the polyvinyl alcohol-based material is blended into the composition for a heat-insulating material as described above such that the polyvinyl alcohol-based material is contained in the heat-insulating material A, when high temperature is applied to the heat-insulating material A as described above and the polyvinyl alcohol-based material is broken down, water is generated also in the atmosphere where oxygen is insufficient. Therefore, at the same time as the thermal energy is consumed when the polyvinyl alcohol-based material is broken down, the thermal energy is also consumed as heat of vaporization of the generated water, and the like. Thus, it is possible to obtain a superior heat-insulating effect by the consumption of the thermal energy. If a material in the form of fibers such as vinylon fibers is used as the polyvinyl alcohol-based material, it is also possible to obtain a reinforcing effect at low temperature.

The blending amount of the polyvinyl alcohol-based material in the composition for a heat-insulating material is not particularly limited, but is preferably in the range of 1 to 20 mass %. If the blending amount is less than 1 mass %, the above effect by containing the polyvinyl alcohol-based material in the heat-insulating material A cannot be sufficiently obtained. If the blending amount of the polyvinyl alcohol-based material which is not in the form of fibers exceeds 20 mass %, it is not preferred since the strength of the heat-insulating material A is decreased.

The composition for a heat-insulating material according to the present invention may further contains cork particles. Cork is obtained from the bark of cork oak, which is an evergreen tree of Quercus Fagaceae grown in the Mediterranean area (Portugal, Spain, Italy, etc.), and cork particles obtained by pulverizing and purifying the bark of cork oak can be used as the cork particles in the present invention. Cork has an ultrafine cellular structure. Because of the cellular structure, cork has properties of being lightweight and having high heat-insulating properties.

Thus, since the cork particles are contained in the heat-insulating material A, it is possible to reduce the weight of the heat-insulating material A, and it is also possible to decrease the thermal conductivity of the heat-insulating material A to improve the heat-insulating properties. Furthermore, when high temperature is applied, the cork particles are broken down, burnt, sublimated, and carbonized to consume the thermal energy, whereby it is possible to block the high temperature from being transmitted through the heat-insulating material A and to obtain high heat-insulating properties. In addition, a layer of gas generated from the cork by the breakdown and the like is formed on the surface of the heat-insulating material A, whereby it is also possible to obtain the heat-insulating effect.

The particle size of the cork particles is not particularly limited, but is preferably in the range of about 1 to 2000 μm. In addition, the blending amount of the cork particles in the composition for a heat-insulating material is not particularly limited, but is preferably in the range of 5 to 40 mass %. If the blending amount is less than 5 mass %, it is difficult to sufficiently obtain the effect of weight reduction and heat-insulating properties improvement by containing the cork particles. On the other hand, if the blending amount exceeds 40 mass %, it is not preferred since there is a concern that the strength of the heat-insulating material is decreased.

FIG. 2 shows another embodiment of the present invention, in which voids 6 of a honeycomb structure 5 are filled with the above heat-insulating material A. The honeycomb structure 5 is formed in such a form that a large number of voids 6 opened on both surfaces are arranged regularly, and is generally in a honeycomb form in which the shape of each void 6 is formed into a regular hexagon as in (I) of FIG. 2(b). However, the form of the honeycomb structure 5 is not limited to such a honeycomb form, and it suffices that a large number of voids 6 are arranged regularly. For example, various honeycombs are supplied from Showa Aircraft Industry Co., Ltd. as “OX” in (II) of FIG. 2(b), as “flex” in (III) of FIG. 2(b), as “bisect” in (IV) of FIG. 2(b), and as “feather” in (V) of FIG. 2(b), and a honeycomb structure 5 in such a form may also be used according to the purpose. In addition, it is possible to arbitrarily set the opening diameter (cell size) of each void 6 according to the purpose, and, for example, honeycombs of ⅛ inch, 3/16 inch, ¼ inch, ⅜ inch, ½ inch, ¾ inch, and the like are supplied from Showa Aircraft Industry Co., Ltd.

The material of the honeycomb structure 5 is arbitrary, and is, for example, papers such as paper and nonflammable paper, metals such as aluminum, stainless steel, and titanium, aramid paper, poly para-phenylene benzobisoxazole paper, and composite materials such as a carbon-glass composite. For weight reduction, aramid paper is preferable.

A method for filling the voids 6 of the honeycomb structure 5 with the heat-insulating material A is not particularly limited, but, for example, the honeycomb structure 5 may be set in a mold, the composition for a heat-insulating material may be fed into the mold and heated such that the composition for a heat-insulating material is expanded and hardened within the voids 6 of the honeycomb structure 5. In this manner, a heat-insulating material B as shown in FIG. 2(a) can be produced in which the voids 6 of the honeycomb structure 5 are filled with the heat-insulating material A.

In the heat-insulating material B obtained by filling the voids 6 of the honeycomb structure 5 with the heat-insulating material A, the honeycomb structure 5 becomes a skeleton, and thus the strength of the heat-insulating material B is increased and the shape retention of the heat-insulating material B is also favorable. Accordingly, the heat-insulating material B can have excellent handleability when being used.

In the above, as a use of the heat-insulating materials A and B according to the present invention, protection of an airframe flying at a high speed such as a space plane, a recovery capsule, or a rocket has been exemplified, but the present invention is not limited thereto. Various uses are conceivable such as a heat-insulating material for fairing of a rocket, a heat-insulating material at a rocket bottom for heating by engine jet, and a heat-insulating material and a fire spread prevention material around an engine in an automobile, a ship, or the like.

### EXAMPLES

Next, the present invention will be specifically described by means of examples.

### Example 1

940 parts by mass of phenol, 649 parts by mass of 37 mass % formalin, and 4.7 parts by mass of oxalic acid were put into a reaction vessel, refluxed for about 60 minutes, and then reacted for 120 minutes. Thereafter, deliquoring was conducted at normal pressure until the internal temperature reached 160° C., and then deliquoring was conducted under a reduced pressure of 133 hPa, to obtain a novolac type phenol resin having a softening point of 99° C.

The novolac type phenol resin was pulverized with a hammer mill into powder having a particle size of 106 μm or less. Then, 10 parts by mass of hexamethylenetetramine was added as a curing agent to 100 parts by mass of the novolac type phenol resin in the form of powder, and mixed well to obtain a curing agent-containing novolac type phenol resin.

Next, 15 parts by mass of silica fibers (“KA-300E” manufactured by Ashimori Industry Co., Ltd., fiber diameter: 6 μm, fiber length: 5 mm) were used as a fibrous material, 40 parts by mass of aluminosilicate-based micro balloons (“Fillite 200/7” manufactured by Japan Fillite Co., Ltd., particle diameter: 5 to 150 μm, bulk specific gravity: 0.4) were used as inorganic expanded particles, 45 parts by mass of the above curing agent-containing novolac type phenol resin was used as a thermosetting resin, and 5.5 parts by mass of a microcapsule expanding agent (“Microsphere F-50” manufactured by Matsumoto Yushi-Seiyaku Co., Ltd.) was used as an expanding agent. These materials were put into a Henschel mixer and mixed for 10 minutes to obtain a composition for a heat-insulating material.

56 g of the composition for a heat-insulating material was put into a mold having a cavity with a diameter of 50 mm and a height of 60 mm, and the mold was placed into a circulating hot air dryer set previously at 135° C., and heated at 135° C. for 1 hour. Furthermore, the temperature was raised to 175° C., and the mold was heated at 175° C. for 1 hour. In this manner, the composition was expanded and hardened in the mold to mold a heat-insulating material, and then the mold was cooled and the heat-insulating material was taken out.

### Example 2

940 parts by mass of phenol, 1217 parts by mass of 37 mass % formalin, and 23.5 parts by mass of a caustic soda aqueous solution having a concentration of 48 mass % were put into a reaction vessel, refluxed for about 60 minutes, and then reacted for 90 minutes. Then, deliquoring was conducted under a reduced pressure of 133 hPa until the temperature reached 100° C., to obtain a resol type phenol resin in a semisolid form. Methanol was added as a solvent to the resin, to obtain a resol type phenol resin varnish having a solid content of 65 mass %. The viscosity of the resol type phenol resin varnish at 25° C. was 160 mPa·s.

Next, 15 parts by mass of the same silica fibers as in Example 1 were used as a fibrous material, 40 parts by mass of the same aluminosilicate-based micro balloons as in Example 1 were used as inorganic expanded particles, 17 parts by mass (11 parts by mass on a solid content basis) of the above resol type phenol resin varnish and 34 parts by mass of the curing agent-containing novolac type phenol resin obtained in Example 1 were used as a thermosetting resin, and 5.5 parts by mass of the same microcapsule expanding agent as in Example 1 was used as an expanding agent. These materials were put into a Henschel mixer and mixed for 10 minutes. Furthermore, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 3

15 parts by mass of the same silica fibers as in Example 1 were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 1.0 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 4

15 parts by mass of the same silica fibers as in Example 1 were used as a fibrous material, 40 parts by mass of the same aluminosilicate-based micro balloons in Example 1 were used as inorganic expanded particles, 45 parts by mass of an epoxy resin (“AM-030-P” manufactured by DIC Corporation) was used as a thermosetting resin (including 3 parts by mass of dicyandiamide as a curing agent), and 5.5 parts by mass of the same microcapsule expanding agent as in Example 1 was used as an expanding agent. These materials were put into a Henschel mixer and mixed for 10 minutes to obtain a composition for a heat-insulating material.

Then, 56 g of the composition for a heat-insulating material was put into the same mold as in Example 1, and the mold was heated in the same manner as in Example 1 to expand and harden the composition, to obtain a heat-insulating material.

### Example 5

15 parts by mass of alumina fibers (“ALS” manufactured by Mitsubishi Plastics, Inc., fiber diameter: 5 μm, fiber length: 5 mm) were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 6

15 parts by mass of carbon fibers (“TR-066” manufactured by Mitsubishi Rayon Co., Ltd., fiber diameter: 6 μm, fiber length: 6 mm) were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 7

15 parts by mass of aramid fibers (“TECHNORA HCF6-12” manufactured by Teijin Limited, fiber diameter: 12 μm, fiber length: 6 mm) were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent were used. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 8

5 parts by mass of the same silica fibers as in Example 1 were used as a fibrous material, 40 parts by mass of the same aluminosilicate-based micro balloons as in Example 1 were used as inorganic expanded particles, 14 parts by mass of the curing agent-containing novolac type phenol resin obtained in Example 1 and 68 parts by mass (44 parts by mass on a solid content basis) of the resol type phenol resin varnish obtained in Example 2 were used as a thermosetting resin, and 7.1 parts by mass of the same microcapsule expanding agent as in Example 1 was used as an expanding agent were used. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 9

5 parts by mass of the same carbon fibers as in Example 6 were used as a fibrous material, 40 parts by mass of the same aluminosilicate-based micro balloons as in Example 1 were used as inorganic expanded particles, 14 parts by mass of the curing agent-containing novolac type phenol resin obtained in Example 1 and 68 parts by mass (44 parts by mass on a solid content basis) of the resol type phenol resin varnish obtained in Example 2 were used as a thermosetting resin, and 7.1 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a ‘heat-insulating material was put into the same mold as in Example 1, and the mold was heated in the same manner as in Example 1 to expand and harden the composition, to obtain a heat-insulating material.

### Example 10

15 parts by mass of the same silica fibers as in Example 1 were used as a fibrous material, 40 parts by mass of the same aluminosilicate-based micro balloons as in Example 1 were used as inorganic expanded particles, 6 parts by mass of a polyvinyl alcohol (“PVA-224” manufactured by Kuraray Co., Ltd.) was used, 11 parts by mass of the curing agent-containing novolac type phenol resin obtained in Example 1 and 43 parts by mass (28 parts by mass on a solid content basis) of the resol type phenol resin varnish obtained in Example 2 were used as a thermosetting resin, and 4.8 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material,

### Example 11

15 parts by mass of the same silica fibers as in Example 1 were used as a fibrous material, 40 parts by mass of the same aluminosilicate-based micro balloons as in Example 1 were used as inorganic expanded particles, 6 parts by mass of vinylon fibers (“VF-1203-2” manufactured by Kuraray Co., Ltd., fiber diameter: 6 μm, fiber length: 6 mm) were used, 11 parts by mass of the curing agent-containing novolac type phenol resin obtained in Example 1 and 43 parts by mass (28 parts by mass on a solid content basis) of the resol type phenol resin varnish obtained in Example 2 were used as a thermosetting resin, and 4.8 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 12

15 parts by mass of the same silica fibers as in Example 1 were used as a fibrous material, 40 parts by mass of the same aluminosilicate-based micro balloons as in Example 1 were used as inorganic expanded particles, 12 parts by mass of the same vinylon fibers as in Example 11 were used, 8 parts by mass of the curing agent-containing novolac type phenol resin obtained in Example 1 and 38 parts by mass (25 parts by mass on a solid content basis) of the resol type phenol resin varnish obtained in Example 2 were used as a thermosetting resin, and 4.8 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 13

15 parts by mass of the same silica fibers as in Example 1 were used as a fibrous material, 40 parts by mass of hollow beads made of sodium borosilicate glass (“Q-Cel 7014” manufactured by Potters-Ballotini Co., Ltd., particle diameter: 5 to 160 μm, bulk specific gravity: 0.08) were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 14

30 parts by mass of the same silica fibers as in Example 1 were used as a fibrous material, 25 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat insulating material.

### Example 15

5 parts by mass of the same silica fibers as in Example 1 were used as a fibrous material, 50 parts by mass of the same aluminosilicate-based micro balloons as in Example 1 were used as inorganic expanded particles, 11 parts by mass of the curing agent-containing, novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 16

15 parts by mass of the same silica fibers as in Example 1 were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 2.3 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 17

15 parts by mass of the same silica fibers as in Example 1 were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 9.0 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 18

A honeycomb structure (“Aramid Honeycomb” manufactured by Showa Aircraft Industry Co., Ltd., cell size 3/16 inch) formed from a honeycomb in which a resin is impregnated into aramid paper was set within a cavity, of a mold, having a diameter of 50 mm and a height of 60 mm, and 54 g of the composition for a heat-insulating material prepared in Example 3 was put into the mold. Then, the mold was placed into a circulating hot air dryer set previously at 135° C., and heated at 135° C. for 1 hour. Furthermore, the temperature was raised to 175° C., and the mold was heated at 175° C. for 1 hour. In this manner, the composition was expanded and hardened in the mold to conduct molding to fill voids of the honeycomb structure with a heat-insulating material, and then the mold was cooled and a heat-insulating material having the honeycomb structure as a skeleton (see FIG. 2(a)) was taken out.

### Example 19

36 g of the composition for a heat-insulating material prepared in Example 3 was put into a cavity, of a mold, having a diameter of 50 mm and a height of 60 mm. The mold was placed into a circulating hot air dryer set previously at 135° C., and heated at 135° C. for 1 hour. Furthermore, the temperature was raised to 175° C., and the mold was heated at 175° C. for 1 hour. In this manner, the composition was expanded and hardened in the mold to mold a heat-insulating material, and then the mold was cooled and the heat-insulating material was taken out.

### Example 20

84 g of the composition for a heat-insulating material prepared in Example 3 was put into a cavity, of a mold, having a diameter of 50 mm and a height of 60 mm. Then, the mold was placed into a circulating hot air dryer set previously at 135° C., and heated at 135° C. for 1 hour. Furthermore, the temperature was raised to 175° C., and the mold was heated at 175° C. for 1 hour. In this manner, the composition was expanded and hardened in the mold to mold a heat-insulating material, and then the mold was cooled and the heat-insulating material was taken out.

### Example 21

7.5 parts by mass of the same silica fibers as in Example 1 and 7.5 parts by mass of the same carbon fibers as in Example 6 were used as a fibrous material, 40 parts by mass of the same aluminosilicate-based micro balloons as in Example 1 were used as inorganic expanded particles, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 22

15 parts by mass of the same silica fibers as in Example 1 were used as a fibrous material, 20 parts by mass of the same aluminosilicate-based micro balloons as in Example 1 were used as inorganic expanded particles, cork particles (“200A” manufactured by Nagayanagi Co., Ltd., particle diameter: 5 to 75 μm) were used, 11 parts by mass of the curing agent-containing novolac type phenol resin obtained in Example 1 and 52 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 23

0.5 parts by mass of the same silica fibers as in Example 1 were used as a fibrous material, 40 parts by mass of the same aluminosilicate-based micro balloons as in Example 1 were used as inorganic expanded particles, 14.5 parts by mass of the curing agent-containing novolac type phenol resin obtained in Example 1 and 69.2 parts by mass (45 parts by mass on a solid content basis) of the resol type phenol resin varnish obtained in Example 2 were used as a thermosetting resin, and 7.2 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 24

55 parts by mass of the same silica fibers as in Example 1 were used as a fibrous material, 10 parts by mass of the same aluminosilicate-based micro balloons as in Example 1 were used as inorganic expanded particles, 11 parts by mass of the curing agent-containing novolac type phenol resin obtained in Example 1 and 52.3 parts by mass (34 parts by mass on a solid content basis) of the resol type phenol resin varnish obtained in Example 2 were used as a thermosetting resin, and 5.5 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Example 25

50 parts by mass of the same silica fibers as in Example 1 were used as a fibrous material, 3 parts by mass of the same aluminosilicate-based micro balloons as in Example 1 were used as inorganic expanded particles, 12 parts by mass of the curing agent-containing novolac type phenol resin obtained in Example 1 and 53.8 parts by mass (35 parts by mass on a solid content basis) of the resol type phenol resin varnish obtained in Example 2 were used as a thermosetting resin, and 5.6 parts by mass of the same microcapsule expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heart-insulating material was put into the same mold as in Example 1, and the mold was heated in the same manner as in Example 1 to expand and harden the composition, to obtain a heat-insulating material.

### Example 26

5 parts by mass of the same silica fibers as in Example 1 were used as a fibrous material, 55 parts by mass of the same aluminosilicate-based micro balloons as in Example 1 were used as inorganic expanded particles, 10 parts by mass of the curing agent-containing novolac type phenol resin obtained in Example 1 and 46.2 parts by mass (30 parts by mass on a solid content basis) of the resol type phenol resin varnish obtained in Example 2 were used as a thermosetting resin, and 4.8 parts by mass of the same microcapsule, expanding agent as in Example 1 was used as an expanding agent. These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 56 g of the composition for a heat-insulating material was put into the same mold as in Example 1, and the mold was heated in the same manner as in Example 1 to expand and harden the composition, to obtain a heat-insulating material.

### Comparative Example 1

30 parts by mass of the same aluminosilicate-based micro balloons as in Example 1 were used as inorganic expanded particles, 70 parts by mass of the Curing agent-containing novolac type phenol resin obtained in Example 1 was used as a thermosetting resin, and 7.0 parts by mass of the same microcapsule expanding agent as in Example 1 was used as an expanding agent (a fibrous material is not contained). These materials were put into a Henschel mixer and mixed for 10 minutes to obtain a composition for a heat-insulating material.

Then, 56 g of the composition for a heat-insulating material was put into the same mold as in Example 1, and the mold was heated in the same manner as in Example 1 to expand and harden the composition, to obtain a heat-insulating material.

### Comparative Example 2

30 parts by mass of the same silica fibers as in Example 1 were used as a fibrous material, 70 parts by mass of the curing agent-containing novolac type phenol resin obtained in Example 1 was used as a thermosetting resin, and 7.0 parts by mass of the same microcapsule expanding agent as in Example 1 was used as an expanding agent (inorganic expanded particles are not contained). These materials were put into a Henschel mixer and mixed for 10 minutes to obtain a composition for a heat-insulating material.

Then, 56 g of the composition for a heat-insulating material was put into the same mold as in Example 1, and the mold was heated in the same manner as in Example 1 to expand and harden the composition, to obtain a heat-insulating material.

### Comparative Example 3

15 parts by mass of the same silica fibers as in Example 1 were used as a fibrous material, 40 parts by mass of the same aluminosilicate-based micro balloons as in Example 1 were used as inorganic expanded particles, and 11 parts by mass of the curing agent-containing novolac type phenol resin obtained in Example 1 and 52 parts by mass (34 parts by mass on a solid content basis) of the reseal type phenol resin varnish obtained in Example 2 were used as a thermosetting resin (an expanding agent is not contained). These materials were put into a Henschel mixer and mixed for 10 minutes. Next, the mixture was swept off into a stainless vat, and allowed to stand at room temperature for 24 hours to permit methanol to evaporate, to obtain a composition, for a heat-insulating material, in the form of powder.

Then, 84 g of the composition for a heat-insulating material was put into the same mold as in Example 1, Then, the mold was placed into a circulating hot air dryer set previously at 135° C., and heated at 135° C. for 1 hour. Furthermore, the temperature was raised to 175° C., and the mold was heated at 175° C. for 1 hour. In this manner, the composition was expanded and hardened in the mold to mold a heat-insulating material, and then the mold was cooled and the heat-insulating material was taken out.

### Comparative Example 4

50 parts by mass of the same silica fibers as in Example 1 were used as a fibrous material, and 50 parts by mass of the curing agent-containing novolac type phenol resin obtained in Example 1 was used as a thermosetting resin (inorganic expanded particles and an expanding agent are not contained). These materials were put into a Henschel mixer and mixed for 10 minutes to obtain a composition for a heat-insulating material.

Then, 197 g of the composition for a heat-insulating material was put into the same mold as in Example 1. Then, the mold was placed into a circulating hot air dryer set previously at 135° C., and heated at 135° C. for 1 hour. Furthermore, the temperature was raised to 175° C., and the mold was heated at 175° C. for 1 hour. In this manner, the composition was hardened in the mold to mold a heat-insulating material, and then the mold was cooled and the heat-insulating material was taken out.

For the heat-insulating materials of Examples 1 to 20 and Comparative Examples 1 to 4 obtained as described above, bulk specific gravity and thermal conductivity were measured. The bulk specific gravity was obtained by dividing the mass of each heat-insulating material by the volume of each heat-insulating material. In addition, the measurement of thermal conductivity was conducted using a thermal conductivity measuring apparatus “GH-1” manufactured by ULVAC-RIKO, Inc., according to ASTM E1530 by a guarded heat flow meter method.

In addition, on the heat-insulating materials of Examples 1 to 20 and Comparative Examples 1 to 4, an erosion test was conducted for evaluating a damage degree of a surface of a material placed in a stream of gas at a high temperature and a high speed. The test was conducted using an erosion tester manufactured by IHI Corporation, under conditions of heating method: arc heating, heating rate: 2.01 MW/m², stream temperature: 2300° C., stream speed: Mach 3, heating time: 200 seconds, and specimen size: φ50 mm×60 mm. A thickness by which the surface was damaged was measured as a recession amount, and the back surface temperature was measured. In addition, presence/absence of crack of the specimen was inspected, a specimen having no crack was evaluated as “∘”, a specimen having small crack not extending therethrough from its front to its back was evaluated as “Δ”, and a specimen having large crack extending therethrough from its front to its back was evaluated as “×”.

TABLE 1
(blending amount is shown in parts by mass)

| | | Example | | | | | | |
|---|---|---|---|---|---|---|---|---|
| | | 1 | 2 | 3 | 4 | 5 | 6 | 7 |
| Fibrous | Silica fibers | 15 | 15 | 15 | 15 | | | |
| material | Alumina fibers | | | | | 15 | | |
| | Carbon fibers | | | | | | 15 | |
| | Aramid fibers | | | | | | | 15 |
| Inorganic | Aluminosilicate | 40 | 40 | 40 | 40 | 40 | 40 | 40 |
| expanded | Sodium | | | | | | | |
| particles | borosilicate glass | | | | | | | |
| PVA- | PVA | | | | | | | |
| based | Vinylon | | | | | | | |
| material | | | | | | | | |
| Thermosetting | Novolac type | 45 | 34 | 11 | | 11 | 11 | 11 |
| resin | phenol resin | | | | | | | |
| | Resol type phenol | | 11 | 34 | | 34 | 34 | 34 |
| | resin | | | | | | | |
| | Epoxy resin | | | | 45 | | | |
| Expanding agent | | 5.5 | 5.5 | 5.5 | 5.5 | 5.5 | 5.5 | 5.5 |
| Aramid honeycomb structure | | None | None | None | None | None | None | None |
| Physical | Bulk specific | 0.45 | 0.44 | 0.45 | 0.45 | 0.43 | 0.48 | 0.44 |
| properties | gravity | | | | | | | |
| | Thermal | 0.117 | 0.118 | 0.120 | 0.121 | 0.120 | 0.125 | 0.121 |
| | conductivity | | | | | | | |
| | (W/(m · K)) | | | | | | | |
| Erosion test | Recession amount | 5.5 | 5.0 | 4.7 | 8.0 | 4.8 | 5.7 | 6.0 |
| | (mm) | | | | | | | |
| | Back surface | 120 | 119 | 135 | 165 | 130 | 180 | 140 |
| | temperature (° C.) | | | | | | | |
| | Crack | ◯ | ◯ | ◯ | ◯ | ◯ | ◯ | ◯ |

PVA: polyvinyl alcohol

TABLE 2
(blending amount is shown in parts by mass)

| | | Example | | | | | | |
|---|---|---|---|---|---|---|---|---|
| | | 8 | 9 | 10 | 11 | 12 | 13 | 14 |
| Fibrous | Silica fibers | 5 | | 15 | 15 | 15 | 15 | 30 |
| material | Alumina fibers | | | | | | | |
| | Carbon fibers | | 5 | | | | | |
| | Aramid fibers | | | | | | | |
| Inorganic | Aluminosilicate | 40 | 40 | 40 | 40 | 40 | | 25 |
| expanded | Sodium | | | | | | 40 | |
| particles | borosilicate glass | | | | | | | |
| PVA- | PVA | | | 6 | | | | |
| based | Vinylon | | | | 6 | 12 | | |
| material | | | | | | | | |
| Thermosetting | Novolac type | 14 | 14 | 11 | 11 | 8 | 11 | 11 |
| resin | phenol resin | | | | | | | |
| | Resol type phenol | 44 | 44 | 28 | 28 | 25 | 34 | 34 |
| | resin | | | | | | | |
| | Epoxy resin | | | | | | | |
| Expanding agent | | 7.1 | 7.1 | 4.8 | 4.8 | 4.0 | 5.5 | 5.5 |
| Aramid honeycomb structure | | None | None | None | None | None | None | None |
| Physical | Bulk specific | 0.43 | 0.42 | 0.46 | 0.47 | 0.45 | 0.45 | 0.48 |
| properties | gravity | | | | | | | |
| | Thermal | 0.115 | 0.120 | 0.120 | 0.121 | 0.122 | 0.120 | 0.123 |
| | conductivity | | | | | | | |
| | (W/(m · K)) | | | | | | | |
| Erosion test | Recession amount | 6.0 | 7.5 | 4.2 | 4.0 | 3.5 | 5.0 | 4.0 |
| | (mm) | | | | | | | |
| | Back surface | 142 | 162 | 121 | 119 | 112 | 137 | 122 |
| | temperature (° C.) | | | | | | | |
| | Crack | ◯ | ◯ | ◯ | ◯ | ◯ | ◯ | ◯ |

PVA: polyvinyl alcohol

TABLE 3
(blending amount is shown in parts by mass)

| | | Example | | | | | | | |
|---|---|---|---|---|---|---|---|---|---|
| | | 15 | 16 | 17 | 18 | 19 | 20 | 21 | 22 |
| Fibrous | Silica fibers | 5 | 15 | 15 | 15 | 15 | 15 | 7.5 | 15 |
| material | Alumina fibers | | | | | | | | |
| | Carbon fibers | | | | | | | 7.5 | |
| | Aramid fibers | | | | | | | | |
| Inorganic | Aluminosilicate | 50 | 40 | 40 | 40 | 40 | 40 | 40 | 20 |
| expanded | Sodium | | | | | | | | |
| particles | borosilicate glass | | | | | | | | |
| PVA- | PVA | | | | | | | | |
| based | Vinylon | | | | | | | | |
| material | | | | | | | | | |
| Cork particles | | | | | | | | | 20 |
| Thermosetting | Novolac type | 11 | 11 | 11 | 11 | 11 | 11 | 11 | 11 |
| resin | phenol resin | | | | | | | | |
| | Resol type phenol | 34 | 34 | 34 | 34 | 34 | 34 | 34 | 34 |
| | resin | | | | | | | | |
| | Epoxy resin | | | | | | | | |
| Expanding agent | | 5.5 | 2.3 | 9.0 | 5.5 | 5.5 | 5.5 | 5.5 | 5.5 |
| Aramid honeycomb structure | | None | None | None | Presence | None | None | None | None |
| Physical | Bulk specific | 0.43 | 0.49 | 0.40 | 0.48 | 0.30 | 0.70 | 0.45 | 0.45 |
| properties | gravity | | | | | | | | |
| | Thermal | 0.116 | 0.125 | 0.115 | 0.125 | 0.060 | 0.165 | 0.123 | 0.119 |
| | conductivity | | | | | | | | |
| | (W/(m · K)) | | | | | | | | |
| Erosion test | Recession amount | 4.5 | 4.7 | 7.0 | 4.0 | 7.5 | 3.8 | 5.0 | 5.5 |
| | (mm) | | | | | | | | |
| | Back surface | 118 | 138 | 125 | 140 | 129 | 141 | 155 | 115 |
| | temperature (° C.) | | | | | | | | |
| | Crack | ◯ | ◯ | ◯ | ◯ | ◯ | ◯ | ◯ | ◯ |

PVA: polyvinyl alcohol

TABLE 4
(blending amount is shown in parts by mass)

| | | Example | | | |
|---|---|---|---|---|---|
| | | 23 | 24 | 25 | 26 |
| Fibrous | Silica fibers | 0.5 | 55 | 50 | 5 |
| material | Alumina fibers | | | | |
| | Carbon fibers | | | | |
| | Aramid fibers | | | | |
| Inorganic | Aluminosilicate | 40 | 10 | 3 | 55 |
| expanded | Sodium | | | | |
| particles | borosilicate glass | | | | |
| PVA- | PVA | | | | |
| based | Vinylon | | | | |
| material | | | | | |
| Thermosetting | Novolac type | 14.5 | 11 | 12 | 10 |
| resin | phenol resin | | | | |
| | Resol type phenol | 45 | 34 | 35 | 30 |
| | resin | | | | |
| | Epoxy resin | | | | |
| Expanding agent | | 7.2 | 5.5 | 5.6 | 4.8 |
| Aramid honeycomb structure | | None | None | None | None |
| Physical | Bulk specific | 0.45 | 0.50 | 0.55 | 0.40 |
| properties | gravity | | | | |
| | Thermal | 0.120 | 0.145 | 0.155 | 0.110 |
| | conductivity | | | | |
| | (W/(m · K)) | | | | |
| Erosion test | Recession amount | 8.0 | 7.5 | 7.0 | 8.5 |
| | (mm) | | | | |
| | Back surface | 135 | 155 | 193 | 185 |
| | temperature (° C.) | | | | |
| | Crack | Δ | Δ | Δ | Δ |

PVA: polyvinyl alcohol

TABLE 5
(blending amount is shown in parts by mass)

| | | Comparative Example | | | |
|---|---|---|---|---|---|
| | | 1 | 2 | 3 | 4 |
| Fibrous | Silica fibers | — | 30 | 15 | 50 |
| material | Alumina fibers | | | | |
| | Carbon fibers | | | | |
| | Aramid fibers | | | | |
| Inorganic | Aluminosilicate | 30 | — | 40 | — |
| expanded | Sodium | | | | |
| particles | borosilicate glass | | | | |
| PVA- | PVA | | | | |
| based | Vinylon | | | | |
| material | | | | | |
| Thermosetting | Novolac type | 70 | 70 | 11 | 50 |
| resin | phenol resin | | | | |
| | Resol type phenol | | | 34 | |
| | resin | | | | |
| | Epoxy resin | | | | |
| Expanding agent | | 7.0 | 7.0 | — | — |
| Aramid honeycomb structure | | None | None | None | None |
| Physical | Bulk specific | 0.41 | 0.53 | 0.70 | 1.60 |
| properties | gravity | | | | |
| | Thermal | 0.070 | 0.125 | 0.31 | 0.56 |
| | conductivity | | | | |
| | (W/(m · K)) | | | | |
| Erosion test | Recession amount | 25.0 | 15.5 | 7.0 | 3.0 |
| | (mm) | | | | |
| | Back surface | 250 | 215 | 235 | 255 |
| | temperature (° C.) | | | | |
| | Crack | X | X | X | Δ |

PVA: polyvinyl alcohol

As seen from Tables 1 to 3, in each Example, the bulk specific gravity was not greater than 1.0, the thermal conductivity was not greater than 0.2 W/(m·K), and it was possible to obtain a lightweight heat-insulating material having excellent heat-insulating properties. In addition, in any of these Examples, no large crack was observed.

Meanwhile, as seen from Table 4, in Comparative Example 1 containing no fibrous material, the recession amount was large, and there was a problem in terms of strength. In addition, in Comparative Example 2 in which expansion was conducted using the expanding agent but no inorganic expanded particles are contained, the bulk specific gravity was high, and thus weight reduction was insufficient. In Comparative Example 3 in which the inorganic expanded particles are contained but no expanding agent was blended and expansion was not conducted, the bulk specific gravity was high and thus weight reduction was insufficient, and the thermal conductivity was also high and thus the heat-insulating properties were insufficient. Furthermore, in Comparative Example 4 in which no inorganic expanded particles are contained, no expanding agent was blended, and expansion was not conducted, the bulk specific gravity and the thermal conductivity were further high. Moreover, in Comparative Examples 1 to 3, large crack occurred.

In addition, in Example 23, the blending amount of the fibrous material is small; in Example 24, the blending amount of the fibrous material is large; in Example 25, the blending amount of the inorganic expanded particles is small; and in Example 26, the blending amount of the inorganic expanded particles is large. In any of these Examples, it was possible to ensure performance at a certain level or higher, but the performance was inferior to that of the other Examples.

### DESCRIPTION OF THE REFERENCE CHARACTERS

1 fibrous material

2 inorganic expanded particles

3 expanded resin layer

5 honeycomb structure

6 void

1. A composition for a heat-insulating material for obtaining a heat-insulating material which consumes thermal energy at high temperate by an action selected from breakdown, burning, sublimation, and carbonization, the composition containing a fibrous material, inorganic expanded particles, a thermosetting resin, and an expanding agent.

2. The composition for a heat-insulating material according to claim 1, wherein the composition contains a polyvinyl alcohol-based material selected from a polyvinyl alcohol and a polyvinyl acetal resin.

3. The composition for a heat-insulating material according to claim 1, wherein the composition contains cork particles.

4. The composition for a heat-insulating material according to claim 1, wherein a material selected: inorganic fibers including alumina fibers, glass fibers, silica fibers, alumina-silica composite oxide fibers, silicon carbide fibers, boron fibers, and carbon fibers; and organic fibers including aramid fibers, poly para-phenylene benzobisoxazole fibers, acrylic fibers, acetate fibers, nylon fibers, and vinylidene fibers, is used as the fibrous material.

5. The composition for a heat-insulating material according to claim 1, wherein a resin selected from phenol resins, furan resins, polyimides, silicone resins, epoxy resins, unsaturated polyesters, polyurethanes, melamine resins, and modified resins thereof, is used as the thermosetting resin.

6. A heat-insulating material formed by expanding and hardening the composition for a heat-insulating material according to claim 1.

7. The heat-insulating material according to claim 6, wherein the heat-insulating material has a bulk specific gravity of 1.0 or less and a thermal conductivity of 0.2 W/(m·K) or less.

8. A heat-insulating material formed by expanding and hardening the composition for a heat-insulating material according to claim 1, within voids of a honeycomb structure.
